(19) United States
(12) Patent Application Publication
(10) Pub. No.: US 2025/0139192 A1
(43) Pub. Date: May 1, 2025

(54) SYSTEM AND METHOD FOR HYPERGRAPH MATCHING BASED ON SECOND AND THIRD ORDER COMPATIBILITIES WITH CUR DECOMPOSITION

(71) Applicant: Centre for Intelligent Multidimensional Data Analysis Limited, Pak Shek Kok (HK)

(72) Inventors: Qixuan Zheng, Pak Shek Kok (HK); Hong Yan, Pak Shek Kok (HK)

(21) Appl. No.: 18/497,308

(22) Filed: Oct. 30, 2023

(51) Int. Cl. G06F 17/16

(52) U.S. Cl. CPC G06F 17/16

(57) ABSTRACT

Hypergraph matching algorithms have better matching accuracy at the cost of exponentially increased computation resources. Recent kd-tree-based approximate nearest neighbor (ANN) methods represent the compatibility between two hypergraphs as a sparse tensor, which still requires exhaustive calculation for large-scale graph matching problems. To decrease the computation for the large-scale hypergraph matching problem, this work proposes a CUR-based cascaded framework to generate the sparse compatibility tensor by decreasing the calculated compatibility between two graphs. The framework includes a CUR-based second-order graph matching algorithm, a fiber CUR-based tensor generation method, and a PRL-based hypergraph matching algorithm that is specifically suitable for sparse tensors. The experiment results show that the proposed cascaded framework requires much fewer computation resources and can effectively deal with larger-scale graph-matching problems. The PRL-based hypergraph matching algorithm can achieve a higher matching accuracy with a sparser tensor than existing methods.

### TECHNICAL FIELD

The invention relates to a system and a method for hypergraph matching based on second and third order compatibilities with CUR decomposition.

### BACKGROUND

Finding the correspondences between a pair of features has many applications in computer vision and pattern recognition tasks like feature tracking, image classification, object detection, and gene-drug association identification. Given two sets of points, the task is to find the matching pairs based on the extracted features. Graph matching can solve the problem effectively by representing each point set as a graph. Every point in the set is described as a node, while the edge describes the structural relationships between the points. The graph-matching problem aims to minimize an objective function composed of unary or pairwise terms. Earlier related tasks aimed to find the correspondences between visual features like key points, edges, or raw pixels. A common approach is to define a measurement of the compatibility between two features, like SIFT, and match features in the first image to their nearest neighbors in the second one. Such approaches may not work well because of the ambiguities like repeated patterns and textures.

To further increase the matching performance, some methods consider the geometric consistency between a pair of features, known as second-order graph matching. To describe the compatibility between the edges of two feature sets, one prior art system used the distance between two features without considering the invariance of rotation, one prior art method used features based on distances and angles to leverage between rotation and scale invariance. Another prior art method assumed that the adjacent points in the first image should also be close to each other in the target image. For pairwise matching, known as second-order graph matching, the problem can be considered a quadratic assignment problem (QAP), which is NP-hard. Therefore, various methods have been proposed to match the pairwise features with soft constraint approximations. Some prior art system was configured to calculate the rank-1 approximation of the compatibility matrix. In one prior art, a random walk view for graph matching was introduced with a reweighting jump scheme. In another prior art system, more geometric insights into the problem and further reduces the space and time complexities. The similarity between pairwise features is hard to define in second-order graph matching problems. Therefore, the second-order graph matching algorithms usually fail with patterns under rotation and scaling deformations.

In the past decade, researchers have proposed models with higher-order graphs, known as hypergraphs. Traditional graphs consider the edge as the association between a pair of nodes. Hypergraph considers the edge, called hyperedge, the association among multiple nodes. Compared with second order graph matching, higher-order methods integrate better geometric information and can handle better with transformations like scaling or rotation. The hypergraph matching problem considers the compatibility between two hypergraphs as a high-order tensor. The objective function aims to find the maximization over all permutations of the features.

Recent hypergraph matching methods achieve more accurate results with higher-order similarity measurements. One prior art considered the matching problem to be related to the Kronecker product. Another prior system represented the high-order compatibilities between two hypergraphs as a sparse tensor with approximate nearest neighbor (ANN)-based method, which is heavily employed for generating compatibility tensors in later hypergraph matching works. Another prior art system was configured to reweighted walk hypergraph matching problems. Another prior art was attempted to be solved by a linear or quadratic assignment problem sequence. One prior art decomposed the problem with the alternating direction method of multipliers. Another prior art system considered the problem a non-cooperative multiplayer game and extracts the stable strategies to find the matching accuracy. In the past decade, few works have worked on optimizing the compatibility tensors of the hypergraph matching problems. Although the ANN-based method can significantly decrease the time complexity during the matching process, it requires large computation costs to calculate the compatibility tensor.

In the past few years, with the fast development of deep learning, several learning-based algorithms have been proposed to learn the parameters of graph-matching problems in a data-driven way. There were attempts to design the end-to-end deep learning framework to solve graph-matching problems. One prior art used graph convolutional network (GCN) to project the graph structure to node features. Both methods learn the graph attributes and match the nodes with the Sinkhorn algorithm. One prior art system turned the second-order graph matching problem into a node classification problem on an association graph. In one prior art, the learning-based method directly learns the compatibility matrices/tensors via data. They learn different models on different datasets to solve the graph/hypergraph matching problems. Although they achieve state-of-the-art accuracy on the current test dataset, the models trained by the algorithms are not unified. Moreover, the GCN network requires enormous computation resources for large-scale graph-matching problems, so the current learning-based hypergraph matching algorithms can only deal with relatively small-scale problems.

### SUMMARY OF THE INVENTION

In accordance with a first aspect of the present invention, there is provided a computer system for second-order graph matching, said system comprising:

a memory storing a representation of at least two set of nodes ( [symbol] ₁, [symbol] ₂) and a compatibility matrix (H) representing similarities between edges of the nodes;
a processing unit configured to receive the compatibility matrix and execute machine instructions comprising the steps of:
retrieving a subset of columns and rows from the compatibility matrix (H) in the memory to compose a first matrix (C);
conducting CUR decomposition of the tensor to generate an approximation matrix formed by the first matrix and a second matrix (U_{*}); and
applying a soft-constraint second-order graph-matching algorithm on the approximation matrix to generate an assignment matrix (X);
identifying a predetermined entries (k) with highest probabilities in the assignment matrix as match sets of the nodes ( [symbol] ᵢ).

In accordance with the first aspect, each of the at least two set of nodes has a cardinal greater than the columns and rows of the first matrix.

In accordance with the first aspect, the compatibility matrix is decomposed with the first matrix (C) and a second matrix (U_{*}), wherein each of the first matrix and second matrix has a small size than that of the compatibility matrix.

In accordance with the first aspect, the second matrix is generated by

$${U}_{*} = arg {min}_{U} {‖ {R}_{Ω} ( H ) - {R}_{Ω} ( {CUC}^{T} ) ‖}_{F} .$$

In accordance with the first aspect, the first matrix (C) comprises randomly selected columns and rows retrieve from the compatibility matrix (H).

In accordance with the first aspect, the machine instructions further comprise the step of generating a compatibility tensor with respect to the match sets of the nodes ( [symbol] ᵢ).

In accordance with the first aspect, the compatibility tensor is a sparse tensor.

In accordance with the first aspect, the compatibility tensor is generated by a Fiber-CUR-based tensor generation.

In accordance with the first aspect, the Fiber-CUR-based tensor generation comprises the steps of:
selecting hyperedges from one of the match sets of the nodes ( [symbol] ₁);
comparing the selected hyperedges with a hyperedge subset comparing the selected {{i₂,j₂,:}, {i₂,:,k₂}, {:,j₂,k₂}} ε ϵ₂ where i₂ ε [symbol] ᵢ_{₁},j₂ ε [symbol] ⱼ_{₁}, and k₂ ε [symbol] ₖ_{₁};
selecting r nearest neighbors for each hyperedge in the source graph to generate the compatibility tensor.

In accordance with the first aspect, the machine instructions further comprise the step of generating a relaxed assignment matrix (X) with respect to the compatibility tensor.

In accordance with the first aspect, the relaxed assignment matrix (X) is generated by a probabilistic relaxation labeling algorithm.

In accordance with the first aspect, the probabilistic relaxation labeling algorithm comprises the step of generating the probability of node I from one of the match sets of the nodes and node j from another match sets of the nodes.

In accordance with the first aspect, the probability of node i is associated with node j is represented by

$${p}_{i}^{( k + 1 )} ( j ) = \frac{{[ {\sum }_{l} {\sum }_{m} {R}_{il} ( j , m ) {p}_{l}^{( k )} ( m ) ]}^{2}}{{\sum }_{i} {[ {\sum }_{l} {\sum }_{m} {R}_{il} ( j , m ) {p}_{l}^{( k )} ( m ) ]}^{2}}$$

In accordance with the first aspect, the probability is replaced with the vector x, wherein which x is the columnwise flatten of a soft-constraint assignment matrix.

In accordance with the first aspect, the vector x is adapted to be normalized as

$${\hat{x}}^{( k + 1 )} = {( α \hat{m} ⊙ {x}^{( k )} + ( 1 - α ) {⊗}_{1} {x}^{( k )} {⊗}_{2} {x}^{( k )} )}^{2}$$

In accordance with the first aspect, the relaxation labeling algorithm halts when relaxed assignment matrix X converges.

In accordance with the first aspect, the at least two set of nodes ( [symbol] ₁, [symbol] ₂) are corresponding points from templates with regular shapes.

In accordance with the first aspect, the templates with regular shapes are from two different objects, including different Chinese characters.

In accordance with the first aspect, the at least two set of nodes ( [symbol] ₁, [symbol] ₂) are corresponding points from frame image sequence of two objects, including images of buildings from two images or two frames of a stream of images (video).

In accordance with the first aspect, at least two set of nodes ( [symbol] ₁, [symbol] ₂) are corresponding feature points, and shapes from different 2D and 3D objects.

### BRIEF DESCRIPTION OF THE DRAWINGS

Embodiments of the present invention will now be described, by way of example, with reference to the accompanying drawings in which:

FIG. 1 is a schematic diagram of a computer server which is arranged to be implemented as system for analyzing images in accordance with an embodiment of the present invention.

FIG. 2 is a flow chart of the proposed hypergraph matching framework according to an embodiment of a preferred embodiment of the present invention.

FIG. 3, in parts (a) and (b), provides diagrams showing a comparison between traditional ANN-based and the CUR-based tensor generation methods according to embodiments of the present invention.

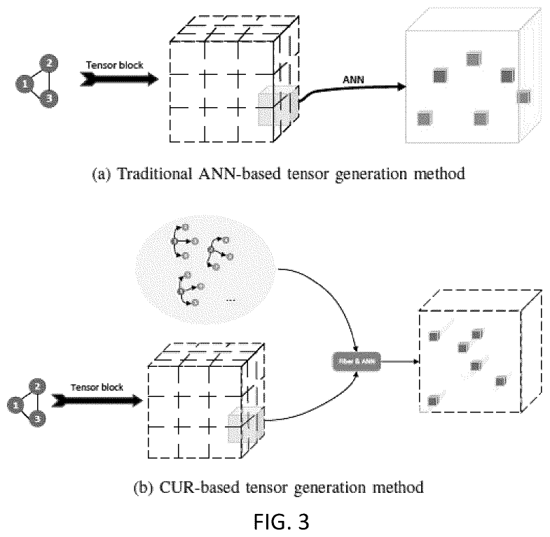

FIG. 4, in parts (a) through (c), provides graphs showing the results of the comparison between ANN and CUR-based method of an embodiment of the present invention.

FIG. 5 is a diagram showing examples of geometric deformations with rotation, scaling, adding noise, and outliers on datasets with specific shapes.

FIG. 6 provides, at (a), a diagram showing the matching result with deformation as rotation with angle [−30°,30°]; at (b),a diagram showing the matching result with deformation as scale on x-coordinate with scaling factor 1.1^{β}, where β ε [−5,5]; at (c), a diagram showing the matching result with deformation as adding noise with ρ/ρ₀=[0,0.1]; and, at (d), a diagram showing the matching result with deformation as adding n outliers where outlier ratio=nₗ/n₁.

FIG. 7 provides, at (a), a diagram showing comparison results on House and Hotel dataset with various matching algorithms; at (b), a diagram showing comparison results on House and Hotel dataset with various matching algorithms; at (c), a diagram showing comparison results on House and Hotel dataset with various matching algorithms; and at (d), a diagram showing comparison results on House and Hotel dataset with various matching algorithms.

FIG. 8 is a diagram showing results on Cars and Motorbikes datasets with various state-of-the-art hypergraph matching algorithms using ANN and CUR-based tensor generation method.

FIG. 9 provides, at (a) through (d), diagrams showing Car datasets matching example using an example of a third-order hypergraph matching algorithms with ANN; and, at (e) through (h), diagrams showing Car datasets matching example using an example of a third-order hypergraph matching algorithms with CUR-based tensor generation methods.

FIG. 10 provides, at (a) through (d), diagrams showing Motor datasets matching example using an example of a third-order hypergraph matching algorithms with ANN; and, at (e) through (h), diagrams showing Motor datasets matching example using an example of a third-order hypergraph matching algorithms CUR-based tensor generation methods.

FIG. 11, at (a), provides a diagram showing the average hit rate on a 100-vs-100 synthetic dataset with σ=0.02 using the CUR-based second-order graph matching algorithm, and, at (b), the average accuracy on the 20-vs-30 CMU house dataset.

FIG. 12, at (a), provides a diagram showing results of 100-vs-120 synthetic dataset with different noise levels using CUR-based tensor generation method and PRL-based hypergraph matching algorithm, and, at (b), the results of 100-vs-120 synthetic dataset with different noise levels using CUR-based tensor generation method and PRL-based hypergraph matching algorithm.

FIG. 13, at parts (a) through (c), provides diagrams showing results on 100-vs-120 synthetic dataset with PRL-based matching algorithm.

### DETAILED DESCRIPTION OF THE PREFERRED EMBODIMENTS

Embodiments of the present invention may be designed to be implemented in digital computing system to improve the efficiency of handing graph and hypergraph matching.

In the present embodiment of the invention, there is provided a cascaded second and third-order hypergraph matching framework based on CUR decomposition for large-scale graph matching problems. The method provided in the present invention has less computation complexity than the traditional ANN-based tensor generation methods. The PRL based hypergraph matching algorithm of the present invention has a fast convergence speed on a sparse compatibility tensor. The experiment results demonstrate that the CUR-based tensor generation method and PRL-based matching algorithm of the present invention can lead to a higher matching accuracy with a sparser compatibility tensor. With less computation and fewer nonzero elements, the proposed method can deal with larger-scale graph-matching problems with the same computation resources and has more compatibility use in this big-data era.

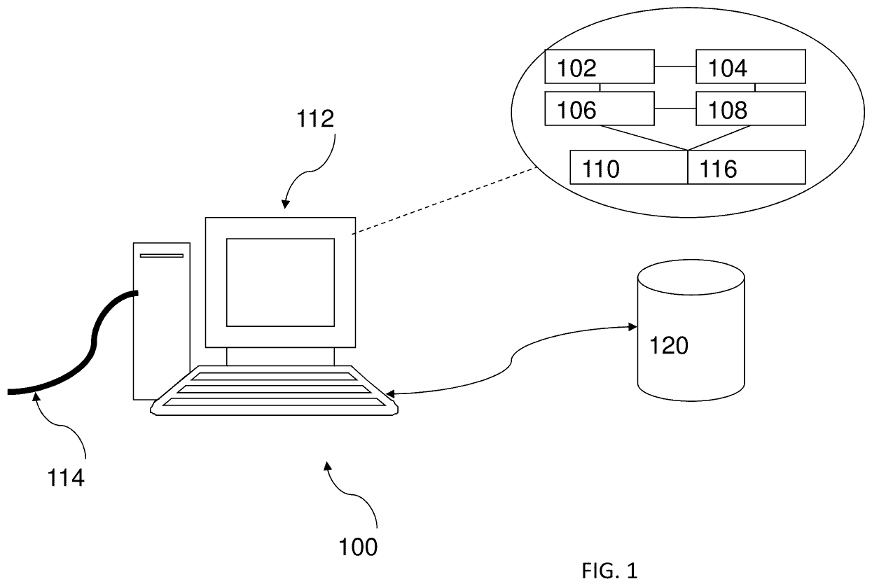

In one prefer embodiment of the present invention, there is provided a computer system as shown in FIG. 1 for second-order graph matching. The system comprising a memory storing a representation of at least two set of nodes ( [symbol] ₁, [symbol] ₂) and a compatibility matrix (H) representing similarities between edges of the nodes; and a processing unit configured to receive the compatibility matrix and execute machine instructions.

Such machine instructions comprise the steps of: retrieving a subset of columns and rows from the compatibility matrix (H) in the memory to compose a first matrix (C); conducting CUR decomposition of the tensor to generate an approximation matrix formed by the first matrix and a second matrix (U_{*}); applying a soft-constraint second-order graph-matching algorithm on the approximation matrix to generate an assignment matrix (X); and identifying a predetermined entries (k) with highest probabilities in the assignment matrix as match sets of the nodes ( [symbol] ᵢ).

Each of the at least two set of nodes has a cardinal greater than the columns and rows of the first matrix. The compatibility matrix is decomposed with the first matrix (C) and a second matrix (U_{*}), wherein each of the first matrix and second matrix has a small size than that of the compatibility matrix. The first matrix (C) comprises randomly selected columns and rows retrieve from the compatibility matrix (H). The second matrix may be generated by

$${U}_{*} = arg {min}_{U} {‖ {R}_{Ω} ( H ) - {R}_{Ω} ( {CUC}^{T} ) ‖}_{F} .$$

The machine instructions further comprise the step of generating a compatibility tensor with respect to the match sets of the nodes ( [symbol] ᵢ). The compatibility tensor may be a sparse tensor and generated by a Fiber-CUR-based tensor generation. The Fiber-CUR-based tensor generation comprises the steps of: selecting hyperedges from the source hypergraph [symbol] ₁; comparing the selected hyperedges with a hyperedge subset {i₂,j₂:}, {i₂,:,k₂}, {:,j₂,k₂} ε ϵ₂ where i₂ ε [symbol] ᵢ_{₁},j₂ ε [symbol] ⱼ_{₁}, and k₂ ε [symbol] ₖ_{₁}; and selecting r nearest neighbors for each hyperedge in the source graph to generate the compatibility tensor.

The machine instructions further comprise the step of generating a relaxed assignment matrix (X) with respect to the compatibility tensor. The relaxed assignment matrix (X) is generated by a probabilistic relaxation labeling algorithm. The probabilistic relaxation labeling algorithm comprises the step of generating the probability of node i from one of the match sets of the nodes and node j from another match sets of the nodes. The probability of node i is associated with node j is represented by

$${p}_{i}^{( k + 1 )} ( j ) = \frac{{[ {\sum }_{l} {\sum }_{m} {R}_{il} ( j , m ) {p}_{l}^{( k )} ( m ) ]}^{2}}{{\sum }_{i} {[ {\sum }_{l} {\sum }_{m} {R}_{il} ( j , m ) {p}_{l}^{( k )} ( m ) ]}^{2}} .$$

Further, the probability can be replaced with the vector x, wherein which x is the column-wise flatten of a soft-constraint assignment matrix. The vector x is adapted to be normalized as

\hat{x}^{(k+1)}=(α\hat{m} ⊙ x^{(k)}+(1−α) [symbol] ⊗₁ x^{(k)} ⊗₂ x^{(k)})². The relaxation labeling algorithm will continue to generate iteration of relaxed assignment matrix X until the relaxed assignment matrix X converges.

The at least two set of nodes ( [symbol] ₁, [symbol] ₂) may be corresponding points from templates with regular shapes (such as Chinese characters), corresponding points from frame image sequence of buildings, or feature points, and shapes from different 2D and 3D objects.

Hypergraph matching performs better than pairwise graph matching methods at the cost of exponentially increased computation complexity. Considering the n₁ nodes in the source set and n₂ in the target, the second-order matching methods represent the compatibility between the two graphs as a compatibility matrix, which only has a space complexity of O((n₁n₂)²). The k^{th}-order tensor, on the other hand, takes O((n₁n₂)^{k}). Therefore, dealing with large-scale graphmatching problems with a full compatibility tensor is difficult.

To reduce the space occupation of the tensor, one prior art used a kd-tree-based approximate nearest neighbor (ANN) algorithm to compute the compatibility tensor by searching for nearest neighbors between the randomly sampled hyperedges in the source graph and all the hyperedges in the fully connected target graph. The compatibility tensor generated by the ANN-based algorithm is a sparse tensor with only a small proportion of nonzero entries representing the paired hypergraphs with the highest compatibilities. Computing the compatibilities with all the hyperedges in the target graph requires exhaustive computation for large-scale problems. Moreover, achieving a higher matching accuracy requires as many nearest neighbors (highest compatibilities) as possible to increase the probability of finding the ground truth paired neighbor. Therefore, the traditional ANN-based tensor generation method could limit the capability of dealing with large scale hypergraph matching problems.

An embodiment of the present invention provides a framework based on cascaded second and third-order models with CUR decomposition to reduce the matching complexity. The framework includes a CUR-based second-order graph-matching algorithm to provide the rough matching results, a fiber-CUR-based sparse compatibility tensor generation method, and a probability relaxation labeling (PRL) based hypergraph matching algorithm to take advantage of the high tensor sparsity. Experiment results show that the proposed method achieves a much higher accuracy and can deal with larger hypergraph problems in far less computation.

In one embodiment of the present invention, it may be able to concludes:
a cascaded second and third-order hypergraph matching method to deal with large-scale hypergraph matching problems. The framework can deal with thousands of points, more than ten times larger than the state-of-the-art algorithms with the same computing resources.
A CUR decomposition method on the second-order graph matching for the large-scale graph matching problems. This method and the symmetric property of the compatibility matrix can further decrease computation complexity.
a fiber-CUR-based high-order compatibility tensor generation method with the second-order graph matching result to decrease the computation complexity and effectively select the useful sparse tensor entries. This might be the first work to implement computer system for the generation of the compatibility tensor based on the high-order CUR decomposition.
a PRL-based tensor matching algorithm to take into account the high sparsity of the compatibility tensor, which significantly increases the computation efficiency.

Experiment results demonstrate that the above methods provide state-of-the-art matching accuracy by effectively finding the essential neighbors in the compatibility tensor.

As shown in FIG. 1 there is a shown a schematic diagram of a computer system or computer server 100 which is arranged to be implemented as an example embodiment of a system for analyzing compressed video. In this embodiment the system comprises a server 100 which includes suitable components necessary to receive, store and execute appropriate computer instructions. The components may include a processing unit 102, including Central Processing Unit (CPUs), Math Co-Processing Unit (Math Processor), Graphic Processing Unit (GPUs) or Tensor Processing Unit (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114. The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The server 100 may include storage devices such as a disk drive 108 which may encompass solid state drives, hard disk drives, optical drives, magnetic tape drives or remote or cloud-based storage devices. The server 100 may use a single disk drive or multiple disk drives, or a remote storage service 120. The server 100 may also have a suitable operating system 116 which resides on the disk drive or in the ROM of the server 100.

The computer or computing apparatus may also provide the necessary computational capabilities to operate or to interface with a machine learning network, such as neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time.

In this specification, the following notations are used. A pair of matched graphs is represented by [symbol] ₁=(ν₁,ε₁) and [symbol] ₂=(ν₂,ε₂). The matching result of [symbol] ₁ and [symbol] ₂ can be represented by an assignment matrix X ε {0,1}ⁿ^{₁}^{×n}^{₂} where n₁=|ν₁| and n₂=|ν₂| to be stored in the computer memory for processing.

Because the graph matching problem is NP-hard, to approximate the matching result, the elements of the assignment matrix is soft constraint as Xᵢⱼ ε [0,1], ∀i,j, where the value of Xᵢⱼ denotes the probability that i^{th} node in ν₁ matches j^{th} node in ν₂. In one embodiment, every node in [symbol] ₁ matches exactly one point in [symbol] ₂, and every node in [symbol] ₂ matches at most one point in [symbol] ₁, i.e., ∀i,ΣⱼXᵢⱼ=1 and ∀j,ΣᵢXᵢⱼ≤1. In the rest of the specification, [symbol] ₁ is referred to as the source graph and [symbol] ₂ as target graph.

The compatibility matrix of the second-order graph matching problem, H ε [symbol] ⁿ^{₁}ⁿ^{₂}^{×n}^{₁}ⁿ^{₂}, is the unfold of the fourth-order tensor [symbol] ε [symbol] ⁿ^{₁}^{×n}^{₂}^{×n}^{₁}^{×n}^{₂} where Ĥᵢ_{₁}_{^{,j}}₁_{^{,i}}₂_{^{,j}}₂ represents the similarity between edges i₁,j₁ and i₂,j₂. The soft-constraint assignment matrix is flattened as x. The second-order graph-matching problem can be represented as the optimization of the function:

$${max}_{x} {x}^{T} Hx \qquad ( 1 )$$

$$s . t . {\sum }_{j ∈ {ind}_{i}} {x}_{j} = 1 , ∀ i$$

where indᵢ={(i−1)n₂+1, . . . ,in₂} represents the index set of the i^{th} row of X. The high H entries correspond to highly compatible edge pairs. The compatibility matrix is symmetric, which means the compatibility between {i₁,j₁} and {i₂,j₂} is the same as the one between {j₁,i₁} and {j₂,i₂}. Equation (1) becomes a classical Rayleigh quotient problem, and x is associated with the main eigenvector of H.

The k^{th}-order hypergraph-matching problem can be extended as:

$${max}_{x} {⊗}_{1} x {⊗}_{2} ⋯ {⊗}_{k} x \qquad ( 2 )$$

$$s . t . {\sum }_{j ∈ {ind}_{i}} {x}_{j} = 1 , ∀ i$$

where the k^{th}-order compatibility tensor [symbol] represents the compatibility between the hyperedges from the two graphs. ⊗ᵢ is the mode-I product of the tensor and vector, which is calculated as:

$${( {⊗}_{l} x )}_{{i}_{1} , ⋯ , {i}_{l - 1} , {i}_{l + 1} , ⋯ , {i}_{k}} = {\sum }_{{i}_{l}} {H}_{{i}_{1} , ⋯ , {i}_{l} , ⋯ , {i}_{k}} {x}_{{i}_{l}} \qquad ( 3 )$$

[symbol] H is supersymmetric like the second-order compatibility matrix, which means the entries of all the index permutations {i₁, . . . ,iₙ} are equal.

A full k^{th} order compatibility tensor requires O((n₁n₂)^{k}) space complexity. For a 100-vs-100 point matching problem, the second-order compatibility matrix requires 0.75 GB of memory usage, but the third-order compatibility tensor takes more than 7 TB, which is ten thousand times larger. It is therefore impractical to process high-definition images for sophisticated applications such as medical imaging. In particular, for real time application where response time is typically required to be within 10 seconds.

Moreover, the time complexity of (2) is also O((n₁n₂)^{k}). To reduce the exhaustive space and time complexity, the ANN-based method first calculates the full compatibility tensor blocks between t sampled hyperedges in the source graph and all the hyperedges in the target. Then r₁ largest entries in each tensor block will be selected as the entries in the compatibility tensor. The time complexity of (2) will reduced to O(tr₁), which is far less than O((n₁n₂)^{k}). However, each tensor block still requires at least O(n₂^{k}) space complexity.

CUR decomposition is used to compute the low-rank approximation of a matrix with some selected rows and columns from a large matrix. Consider a matrix A ε [symbol] ^{m×n}. By selecting c columns and r rows from A as C ε [symbol] ^{m×c} and R ε [symbol] ^{r×n}, the low-rank approximation of A can be represented as C(C^{†}AR^{†})R, where † is the pseudoinverse of the matrix. C^{†}AR^{†} can be represented as the matrix U. It has been proven that if rank (A)<min {c,r}, U can be directly represented by the intersection of C and R as its pseudoinverse.

The randomized fiber CUR decomposition proposed extended the CUR decomposition to the tensor. The fiber of the tensor is a one-dimensional vector. The fiber v located at (i₁, . . . ,iₖ) of the tensor [symbol] along mode-l can be represented as:

$${v}_{l ; {i}_{1} , ⋯ , {i}_{l - 1} , {i}_{l + 1} , ⋯ , {i}_{k}} = {H}_{{i}_{1} , ⋯ , {i}_{l - 1} , : , {i}_{l + 1} , ⋯ , {i}_{k}} \qquad ( 4 )$$

The method first samples cₗ fibers on mode-l and expands the fibers as matrix Cₗ along mode-l. The intersection of all samples forms tensor [symbol] and Uₗ is the pseudoinverse of the mode-l expansion of [symbol] . The fiber CUR decomposition of the tensor [symbol] can be represented as:

$$\approx {\times }_{l = 1}^{k} ( {C}_{l} {U}_{l} ) \qquad ( 5 )$$

where xₗ represents tensor times matrix along the l^{th} mode.

The performance of the CUR decomposition is highly dependent on the selection of C and R (or [symbol] in high order). The key samples can result in an approximation with high accuracy. Therefore, one of the most important tasks of the CUR decomposition is to find the important samples with less computation.

The second-order compatibility matrix takes n₁n₂×n₁n₂ space complexity. For example, a 1000-vs-1000 graph matching problem requires 7.27 TB of memory usage. It is infeasible to deal with large-scale graph matching problems, including thousands of points, because of its terabytes of memory usage. In an embodiment of the present invention, the low-rank approximation of the compatibility matrix with CUR decomposition is estimated. Instead of directly calculating the whole matrix with terabytes of memory, a small number of rows and columns will be loaded to the system memory and processed. Moreover, because of the symmetric property of the compatibility matrix, only the column sampling would be enough to decrease the computation complexity. The second-order compatibility matrix's sampled columns as matrices C and R^{T} are processed. More entries in the compatibility matrix for a higher low-rank estimation accuracy will be randomly selected and processed. The detailed algorithm is shown in Algorithm 1, c columns from H as C are assumed to be calculated. The second-order compatibility matrix can be decomposed with two smaller size matrices C and U_{*}. The matrix U_{*} ε [symbol] ^{c×c} is calculated as:

$${U}_{*} = arg {min}_{U} {‖ {R}_{Ω} ( H ) - {R}_{Ω} ( {CUC}^{T} ) ‖}_{F} \qquad ( 6 )$$

R_{Ω}(·) represents the matrix entries, including the random entry selection and all the intersection elements of C and C^{T}. ∥. ∥_{F} represents the Frobenius norm of the matrix. During the power iteration process, the multiplication result of Hx can be simplified as:

$$Hx \approx {CU}_{*} ( {C}^{T} x ) \qquad ( 7 )$$

which reduced the time and space complexity from O((n₁n₂)²) to O(cn₁n₂). For large-scale graph matching problems, c<<n₁n₂. The memory usage will be decreased from Terrabytes to Gigabytes, even Megabytes, for large-scale graph matching problems.

The rough second-order graph-matching result X with the CUR decomposition of H is generated in the processing unit of the computing system by applying any soft-constraint second-order graph-matching algorithm. For i ε {1, . . . ,n₁}, k entries with highest probabilities in Xᵢ,: are chosen as the best k match set [symbol] ᵢ. Note that the CUR-based method may lead to lower matching accuracy with fewer sampled rows and columns if the second-order matching is applied only. Nevertheless, it provides a rough result for the following higher-order graph matching, which avoids large-scale infeasibility. All the nodes in [symbol] ₁ and their k best matches in [symbol] ₂, represented as [symbol] ={ [symbol] ₁, . . . , [symbol] ₙ_{₁}} will be used to generate the high-order compatibility tensors.

```
Algorithm 1 CUR-based second-order graph matching
  Input Point sets [symbol]  ₁, [symbol]  ₂ with size n₁n₂, column
indices I,
  entry indices J, k
  Output best k match set [symbol]   = { [symbol]  ₁, ··· , [symbol]  ₙ_{₁}}
  C ← H(:, I) {calculate columns with [symbol]  ₁, [symbol]  ₂}
  U_{*} ← CUR(C, H(J,J)){Based on (6).}
  x ← softConstraintMatching (CU_{*}C^{T} )
  X ← reshape(x)
  for i = 1, ... , n₁ do [symbol]
      ᵢ ← maxIndex(X(i, :), k)
end for
```

In one embodiment of the present invention, the processing unit is configured to use the second-order graph-matching result [symbol] with the best k matches to decrease the calculation, where k<<n₂. For a third-order hyperedge {i₁,j₁,k₁} ε ϵ₁, the method does not need to compare the hyperedge with all the hyperedges in the fully-connected target hypergraph, but smaller a hyperedge set {{i₂,j₂,:}, {i₂,:,k₂}, {:,j₂,k₂}} ε ϵ₂ where i₂ ε [symbol] ᵢ_{₁},j₂ ε [symbol] ⱼ_{₁}, and k₂ ε [symbol] ₖ_{₁}.

In one embodiment of the present invention, the processing unit of the computer system is adapted to select r nearest neighbors for each hyperedge in the source graph. Since each hyperedge is compared with much fewer hyperedges, the complexity of the algorithm can be dropped significantly to O(tk^{d-1}n₂+tr). The total algorithm can be concluded as Algorithm 2. The supersymmetric elements in the compatibility tensor will be removed, and each non-zero element will represent all its supersymmetric correspondences for large-scale hypergraph matching problems.

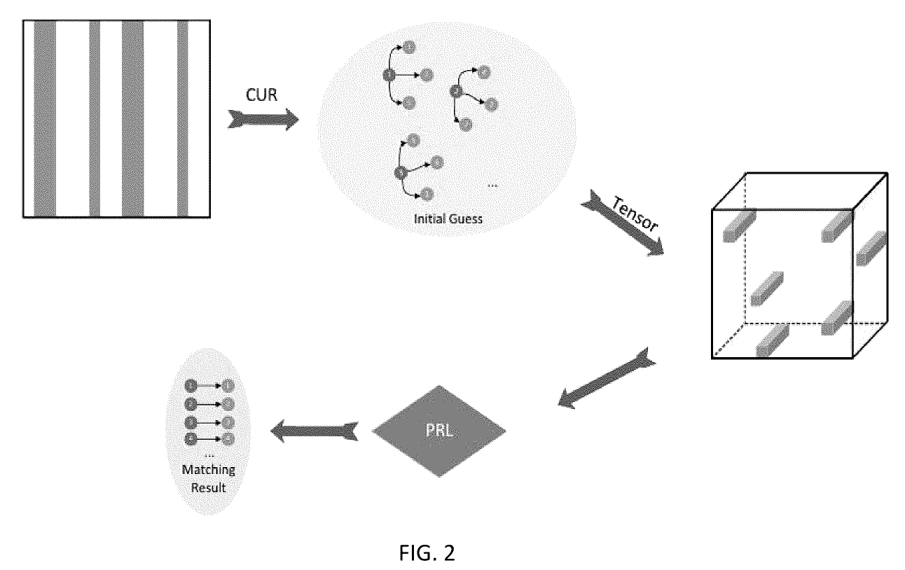

FIG. 2 compares the ANN-based tensor generation method commonly used in state-of-the-art hypergraph matching algorithms and the fiber-CUR-based method according to an embodiment of the present invention using in their mathematical notations. Instead of calculating the whole tensor block and extracting the nearest neighbors in the block, the processing unit of an embodiment of the present invention is programmed to calculate a small number of block fibers and find fewer nearest neighbors in these fibers. (b) shows only the fibers along one mode for a neat view. The fibers are selected in all three modes.

For the third-order hypergraph matching problem, the full tensor size is (n₁n₂)³. The compatibility between each hyperedge in the source graph and all the hyperedges in the fully connected target graph can be represented as a tensor block with size n₂³. The traditional ANN-based method randomly selects t tensor blocks and calculates the full tensor block, which takes the complexity in time and space as tn₂³, and r₁ highest entries are selected in each block. The method of the present invention does not need to calculate all the elements in each tensor block. Similar to the CUR based second-order graph matching, with the second-order graph-matching result [symbol] , the processing unit is configured to calculate the corresponding fibers in the tensor block and select the r highest entries in these fibers. The processing unit of the present invention is adapted to generate the sample fibers of each tensor block, [symbol] . As only the nearest neighbor matter, there is no need to calculate U and [symbol] redundantly during the tensor generation. Therefore, compared with the original randomized fiber CUR decomposition, the compatibility tensor requires less computation during tensor generation and computation complexity during the hypergraph matching process in (2). The sampled fibers are selected based on [symbol] rather than random sampling and are closer to the key samples. It can select the ground truth matching neighbor with a higher probability, resulting in higher matching accuracy. Compared with the ANN-based method, the computation complexity is decreased, and the generated tensor is sparser. Therefore, it can deal with larger-scale hypergraph matching problems.

```
Algorithm 2 Fiber-CUR-based tensor generation
  Input Point sets [symbol]  ₁, [symbol]  ₂with size n₁n₂, best k match
  set [symbol]   = { [symbol]  ₁, ··· , [symbol]  ₙ_{₂}}
  Output Sparse tensor [symbol] [symbol]
    ← empty tensor
  S ← select hyperedges from [symbol]  ₁
  for s = {s₁,s₂, s₃} ∈ S do [symbol]
        ₁ ← {v₁;:,t₂,t₃}, t₂ ∈ [symbol]  ₛ₂ , t₃ ∈ [symbol]  ₛ₃ [symbol]
        ₂ ← {v₂;t₁:,t₃}, t₁ ∈ [symbol]  ₛ₁ , t₃ ∈ [symbol]  ₛ₃ [symbol]
        ₃ ← {v₃;t₁,t₂,:}, t₁ ∈ [symbol]  ₛ₁ , t₃ ∈ [symbol]  ₛ₃ [symbol]
          = set( [symbol]  ₁, [symbol]  ₂, [symbol]  ₃) {Fiber calculation}
        for t ∈ [symbol]   do
                ƒ ← computetupleFeature(t, [symbol]  ₂) [symbol]
                  ← [symbol]   ∪ ƒ
end for [symbol]
          ← search for r nearest-neighbors( [symbol]  , s)
        for n ∈ [symbol]   do [symbol]
                  (index( s), index(n)) ← similarity(descriptor(s),
descriptor(n))
        end for
end for
```

The probabilistic relaxation labeling algorithm (PRL) aims to update the probability that a label is assigned to an object with a set of specified compatibilities, which has been applied in various graph matching problems. For each i ε [symbol] ₁ and j ε [symbol] ₂, pi(j) represents the probability that i is associated with j, which can be updated according to the following equation:

$${p}_{i}^{( k + 1 )} ( j ) = \frac{{p}_{i}^{( k )} ( j ) [ 1 + {q}_{i}^{( k )} ( j ) ]}{{\sum }_{m} {p}_{i}^{( k )} ( m ) [ 1 + {q}_{i}^{( k )} ( m ) ]} \qquad ( 8 )$$

$$with$$

$${q}_{i}^{( k )} ( j ) = {\sum }_{l = 1}^{{n}_{1}} {d}_{il} [ {\sum }_{m = 1}^{{n}_{2}} {r}_{il} ( j , m ) {p}_{l}^{( k )} ( m ) ] \qquad ( 9 )$$

where dᵢₗ is a weight factor representing influence of l on i and Σₗdᵢₗ=1.

In one embodiment, the rᵢₗ(j,m) is replaced with Rᵢₗ(j,m)=0.5(rᵢₗ(j,m)+1) and set dᵢₗ=n₁⁻¹. Then obtain:

$${p}_{i}^{( k + 1 )} ( j ) = \frac{{p}_{i}^{( k )} ( j ) {\sum }_{l} {\sum }_{m} {R}_{il} ( j , m ) {p}_{l}^{( k )} ( m )}{{\sum }_{i} {p}_{i}^{( k )} ( j ) {\sum }_{l} {\sum }_{m} {R}_{il} ( j , m ) {p}_{l}^{( k )} ( m )} \qquad ( 10 )$$

pᵢ^{(k)}(j) where plays the role of weighting. Equation (10) is similar to the standard power iteration. The weighting factors boost the larger probabilities to 1 and the smaller ones to 0.

pᵢ^{(k)}(j) The weighting factors is further replaced with the updated probabilities, (10) will become:

$${p}_{i}^{( k + 1 )} ( j ) = \frac{{[ {\sum }_{l} {\sum }_{m} {R}_{il} ( j , m ) {p}_{l}^{( k )} ( m ) ]}^{2}}{{\sum }_{i} {[ {\sum }_{l} {\sum }_{m} {R}_{il} ( j , m ) {p}_{l}^{( k )} ( m ) ]}^{2}} \qquad ( 11 )$$

which have a more consistent result and faster convergence.

For the numerator of (11), the following is derived:

$$\begin{matrix}{\hat{P}}_{i}^{( k )} ( j ) = {( {\sum }_{l} {\sum }_{m} {R}_{i l} ( j , m ) {p}_{l}^{( k )} ( m ) )}^{2} \\ = {( {R}_{i i} ( j , j ) {P}_{i}^{( k )} ( j ) + {\sum }_{l \neq i} {\sum }_{m} {R}_{i l} ( j , m ) {p}_{l}^{( k )} ( m ) )}^{2}\end{matrix} \qquad ( 12 )$$

Here, it is defined

$${R}_{{i}_{1} {i}_{2}} ( {j}_{1} , {j}_{2} ) = \{ \begin{matrix}{M}_{{i}_{1} , {i}_{2}} & {i}_{1} = {j}_{1} and {i}_{2} = {j}_{2} \\ {H}_{{i}_{1} , {j}_{1} , {i}_{2} , {j}_{2}} & otherwise\end{matrix} \qquad ( 13 )$$

where Hᵢ_{₁},j₁,i₂,j₂ represents the corresponding values in compatibility matrix H and Mᵢ_{₁}_{^{,i}}₂ is related to the first-order compatibility between node i₁ ε [symbol] ₁ and i₂ ε [symbol] ₂. Since Hᵢ_{₁}_{^{,i}}₁_{^{,i}}₂,i₂=0 for all i₁,i₂, (12) can be updated as:

$${\hat{p}}_{i}^{( k + 1 )} ( j ) = {( {M}_{{i}_{1} , {j}_{1}} {p}_{i}^{( k )} ( j ) + {\sum }_{l} {\sum }_{m} {H}_{i , l , j , m} {p}_{l}^{( k )} ( m ) )}^{2} ) \qquad ( 14 )$$

Let δ=ΣₗΣₘH_{i,l,j,m}pₗ^{(k)}(m). To increase the corresponding true matching pᵢ_{₀}^{(k)}(j₀) during every iteration, it must have \hat{p}ᵢ_{₀}^{(k+1)}(j₀=(Mᵢ_{₀}_{^{,j}}₀pᵢ_{₀}^{(k)}(j₀)+δ)²≥pᵢ_{₀}^{(k)}(j₀), which leads to

$$δ \geq 0.25 {M}_{{i}_{0} , {j}_{0}}^{- 2} \qquad ( 15 )$$

In other words, if ΣᵢΣₘH_{i,l,j,m}pₗ^{(k)}(m)≥(0.5M_{i,j}⁻¹)² is guaranteed, the probabilities can converge fast.

Now, the algorithm is extended to a third-order hypergraph matching problem. The steps are shown in Algorithm 3. the probability is replaced with the vector x, which is the columnwise expansion of soft-constraint assignment matrix X. With the normalization process, the processing unit is able to reconfigure (14) as

$${\hat{x}}^{( k + 1 )} = {( α \hat{m} ⊙ {x}^{( k )} + ( 1 - α ) {⊗}_{1} {x}^{( k )} {⊗}_{2} {x}^{( k )} )}^{2} ) \qquad ( 16 )$$

where (·)² is element-wise and α ε [0,1].⊙ denotes the element-wise multiplication of two vectors. The first-order compatibility vector \hat{m} is obtained by column-wise expanding \hat{M}. For a tensor with high sparsity, the non-zero values of ( [symbol] ⊗₁ x^{(k)} ⊗₂ x^{(k)})² are concentrated. Therefore x^{(k)} has a fast converge speed. The proposed PRL-based algorithm suits the compatibility tensor with high sparsity and a relatively low α.

```
Algorithm 3 PRL-based matching algorithm
  Input Sparse compatibility tensor [symbol]  , initial relaxed
assignment matrix X, first-order compatibility vector
\hat{m}, α
  Output Relaxed assignment matrix X
  repeat
  x ← flatten(X)
  δ ← [symbol]   ⊗₁ x ⊗₂ x
  x ← α\hat{m} ⊙ x + (1 − α)δ
  x ← x ⊙ x
  X ← reshape(x)
  X ←norm (X) {Normalize across columns}
until X converges
```

The fiber-CUR-based compatibility tensor generation method (represented as CUR) of the present invention is implemented in the computing system and compared with a series of the ANN-based state-of-the-art hypergraph matching algorithms (represented as ANN): Tensor matching (TM), Hypergraph Matching via Reweighted Random Walks (RRWHM), BCAGM in third-order (BCAGM3), and Alternating Direction Graph Matching (ADGM) with the original implementation. The all-ones vector will be set as the starting point, and the Hungarian algorithm turns the output into a proper matching. The framework of present invention is compared with the state-of-the-art learning-based hypergraph matching algorithm, HNN-HM on the House and Hotel dataset, which is relatively small-scale. Because the prior art HNN-HM fails on large-scale datasets, it cannot even be used to compare with the present invention. The experiments are applied on the computer with an Intel® Core™ i7-9700 CPU @ 3.00 GHz and 16 GB of memory.

The compatibility of two pairwise nodes {i₁,j₁} and {i₂,j₂} is defined as

$${H}_{( {i}_{1} , {i}_{2} ) , ( {j}_{1} , {j}_{2} )} = A ( {v}_{{i}_{1} , {j}_{1}} , {v}_{{i}_{2} , {j}_{2}} ) D ( {d}_{{i}_{1} , {j}_{1}} , {d}_{{i}_{2} , {j}_{2}} ) \qquad ( 17 )$$

where v_{i,j} represents the vector point from node i to j and d_{i,j} represents the distance between node i to j.A(·) denotes the orientation similarity between the pairwise nodes and D(·) represents the distance similarity:

$$A ( {v}_{{i}_{1} , {j}_{1}} , {v}_{{i}_{2} , {j}_{2}} ) = \frac{1}{2} ( 1 + cos ( {v}_{{i}_{1} , {j}_{1}} , {v}_{{i}_{2} , {j}_{2}} ) ) \qquad ( 18 )$$

$$D ( {d}_{{i}_{1} , {j}_{1}} , {d}_{{i}_{2} , {j}_{2}} ) = 1 - ‖ \frac{{d}_{{i}_{1} , {j}_{1}} - {d}_{{i}_{2} , {j}_{2}}}{{d}_{{i}_{1} , {j}_{1}} + {d}_{{i}_{2} , {j}_{2}}} ‖ \qquad ( 19 )$$

The c columns are randomly processed with a uniform distribution as C and another c² random entries in the compatibility matrix to calculate U in (6). The soft-constraint assignment matrix is calculated with the second-order PRL-based algorithm.

For each hyperedge, the feature vector f is generated based on the cosine value of the formed triangle angles. The compatibility between a pair of hyperedges (i₁,j₁,k₁) and (i₂,j₂,k₂) from two graphs is defined as:

$${H}_{( {i}_{1} , {i}_{2} ) , ( {j}_{1} , {j}_{2} ) ( {k}_{1} , {k}_{2} )} = exp ( - γ {‖ {f}_{{i}_{1} , {j}_{1} , {k}_{1}} - {f}_{{i}_{2} , {j}_{2} , {k}_{2}} ‖}_{2}^{2} ) ) \qquad ( 20 )$$

where γ is the inverse of the mean of all generated tensor entries. The processing unit is configured to randomly select t tuples from the source graph. With the same hyperedges, the CUR-based method generates the tensor with r closest neighbors from the target graph, and the ANN-based method generates the tensor with r₁ closest neighbors.

The first-order compatibility matrix M in (16) is calculated as:

$${M}_{i , j} = exp ( - {γ}_{0} {‖ {f}_{i} - {f}_{j} ‖}_{2} ) ) \qquad ( 21 )$$

where fᵢ and fᵢ are the normalized coordinates of i^{th} point in P₁ and j^{th} point in P₂. In this experiment, the processing unit is adapted to normalize the coordinates by subtracting the mean value of the coordinates in each set. γ₀ is the inverse of the mean value of all the distances from points in P₁ to the ones in P₂. M is then column-wisely flattened as the first-order compatibility vector m. During the whole experiment, α is set as 0.2.

The processing unit of the computer system is configured to first evaluate the method of an embodiment of the present invention on a large-scale synthetic dataset. Around 1000 2D points, P, are sampled from a Gaussian distribution [symbol] (0,1). The point set Q are generated by adding Gaussian deformation noise [symbol] (0,σ²) to P. During the experiments, n₁ points from P are selected as source graph inlier points, and n₂ points containing the corresponding matching points of the source graph and additional outlier points from Q will are chosen as target graph points. t tuples are selected from the source points. For the traditional tensor generation method, r₁=300 best matches will be selected for each tuple. For the method according an embodiment of the present invention, c and r are selected relatively small. Each quantitative result was obtained by 50 trials for the plots in this section.

The CUR-based framework is implemented on synthetic datasets with increasing graph sizes n₁n₂.σ is set as 0.005. The result is shown in Table 1. As a comparison, it is shown the results of the ADGM algorithm with the ANN-based method, which is the highest among all the existing state-of the-art hypergraph matching algorithms. It can be observed that with low c and k, the framework according to an embodiment of the present invention can process large-scale graph-matching problems and achieve privilege matching accuracy. The CUR-based method can deal with 1000-vs-1000 matching problems with high accuracy. The traditional ANN-based method, on the other hand, failed to generate the tensor when n₁>300 under the same memory constraint.

TABLE I
RESULTS ON THE SYNTHETIC DATASET WITH ANN-ADGM AND CUR-PRL.

| | | | | Accuracy | | | | Accuracy |
|---|---|---|---|---|---|---|---|---|
| Problem | n₁n₂ | t | r₁ | (ANN + ADGM) | c | k | r | (CUR + PRL) |
| 30 vs 30 | 900 | 900 | 300 | 1 | 15 | 5 | 5 | 1 |
| 30 vs 50 | 1500 | 1500 | 300 | 0.982 | 15 | 5 | 5 | 1 |
| 50 vs 50 | 2500 | 2500 | 300 | 0.988 | 20 | 7 | 7 | 0.998 |
| 50 vs 100 | 5000 | 5000 | 300 | 0.941 | 50 | 10 | 10 | 0.998 |
| 100 vs 100 | 10000 | 10000 | 300 | 0.991 | 100 | 15 | 20 | 1 |
| 200 vs 300 | 60000 | 30000 | — * | — | 150 | 15 | 20 | 0.971 |
| 300 vs 300 | 90000 | 30000 | — | — | 200 | 20 | 20 | 1 |
| 500 vs 500 | 250000 | 30000 | — | — | 200 | 25 | 30 | 0.992 |
| 800 vs 800 | 640000 | 30000 | — | — | 400 | 30 | 50 | 0.962 |
| 1000 vs 1000 | 1000000 | 30000 | — | — | 500 | 50 | 80 | 0.988 |

* Tensor generation fails.

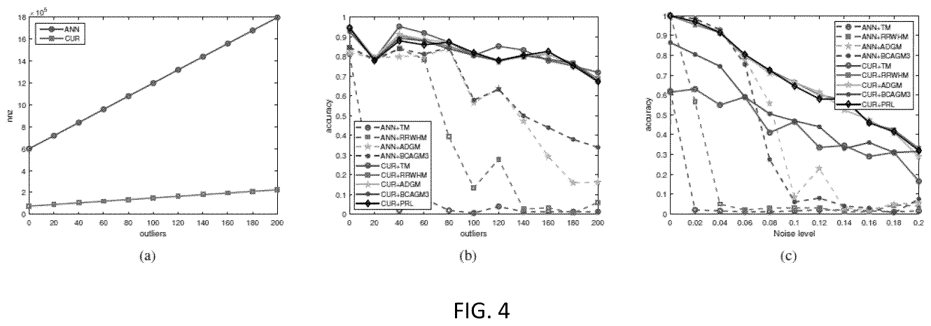

The algorithms are further implemented on a smaller dataset for comparison. The processing unit is first configured to set σ as 0.02, n₁=100, and vary n₂ from 100 to 300, which means there are outliers from 0 to 200 in the target graph [symbol] ₂. The results in FIG. 4 (a) and FIG. 4 (b) show that with about ten times sparser than the compatibility tensor using the ANN-based method, the CUR-based method according to an embodiment of the present invention can generate tensors leading to much higher accuracy. Then the processing unit is configured to set n₂ as 100 with no outlier and vary σ from 0 to 0.1. The result in FIG. 4 (c) shows that the matching algorithms with the CUR-based method have higher matching accuracy than the ones with the ANN-based method. The CUR-based method can generate compatibility tensors with higher robustness.

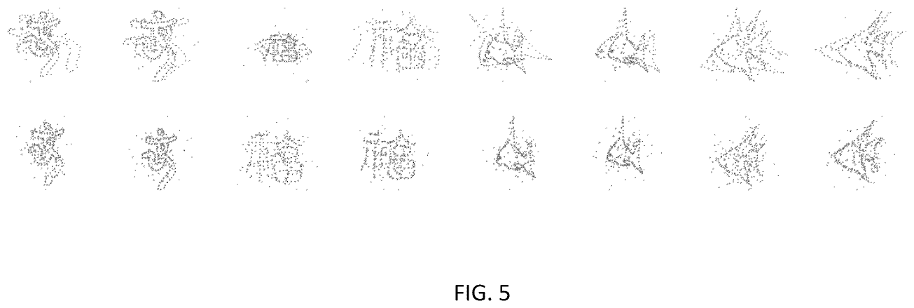

The proposed CUR-based tensor generation method is further evaluated with the PRL-based matching algorithm of an embodiment of the present invention on some existing templates with regular shapes. Compared with the randomly generated synthetic dataset, it can better show the performance of different matching algorithms. Four 2D templates are chosen: whale with 150 points, Chinese character with 105 points, UCF fish with 98 points, and tropical fish with 91 points. The processing unit of the present invention is configured to create the target points by rotation, scaling, adding noise, and adding outliers, as shown in FIG. 5. The matching result generated by an embodiment of the present invention is compared with existing state-of-the art hypergraph matching algorithms. During the experiment, c=100 with k=5 and r=25 for the CUR-based method. For the ANN-based method, r₁ is set as 300.t=0.3n₁n₂ for both methods.

In one embodiment, the processing unit is configured to add different deformation on all the target points. For the rotation case, the processing unit is configured to first rotate the source points with angle θ ε [−30°,30°] and add noise with σ=0.02σ₀, where σ₀ is the standard deviation of all the source point coordinates. For the scaling case, the processing unit is configured to scale the x-coordinate of the 2D point with the scaling factor s=1.1^{β}, where β ε [−5,5] and add noise with σ=0.02σ₀. For adding noise, the processor is configured to vary noise with σ ε [0,0.1σ₀]. To add outliers, the mean value of the source points is assumed to be μ₀, and the processing unit is configured to randomly add nₗ outliers from a Gaussian distribution [symbol] (μ₀,σ₀²), where the outlier ratio

$$\frac{{n}_{l}}{{n}_{1}} ∈ [ 0 , 1 ] .$$

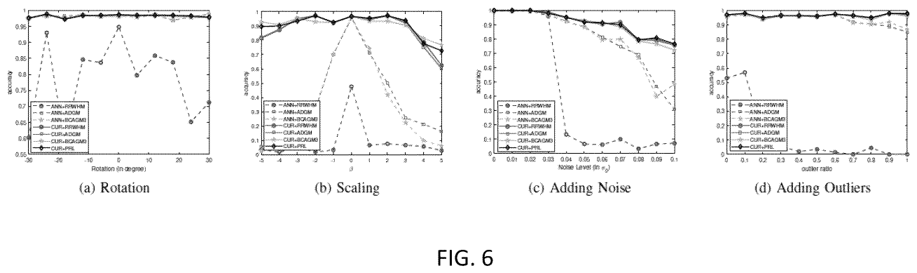

The experiment results are shown in FIG. 6. Due to the rotation invariance of hyperedge features, almost all the algorithms show an average accuracy of nearly 1 under a variant of the rotation deformation regardless of the ANN and CUR-based methods.

The curves of the other three cases demonstrate that the matching algorithms with the method of the present invention outperform ANN. Take the scaling case as an example. The hyperedge features are substantially damaged because the scaling process scales only the x-coordinate of the target points. As the scale factor increases, the matching results of the ANN-based algorithms significantly decrease. In contrast, the method of the present invention may generate compatibility tensors with higher robustness. The performance of the compared matching algorithms is significantly improved and becomes competent after integrating the method of the present invention. Specifically, the result with RRWHM is worse than other algorithms in all the cases due to the adverse noise level. With the assistance of the compatibility tensor generated by the method of the present invention, the matching result of the same RRWHM algorithm is stabilized and shows comparable results with other algorithms.

Previous works have also widely used the CMU House and Hotel datasets to evaluate the matching algorithms. The CMU House dataset has 30 manually labeled feature points on a rotating 3D house model tracked over a 111-frame image sequence. The CMU Hotel dataset has 30 manually labeled points of a hotel model tracked over a 101-frame image sequence. The processing unit is configured to match all possible pairs with baseline (the separation between frames) varying from 10 to 100 by intervals of 10 for the House dataset and from 10 to 90 for the Hotel dataset. The processing unit is configured to match 20 and 30 points in the first image to all 30 points in the second. t=n₁n₂ tuples are selected from the first image. For the ANN-based method, r₁=200 nearest neighbors are chosen for each hyperedge. For the method of the present invention, r is set as 25 and c=300.

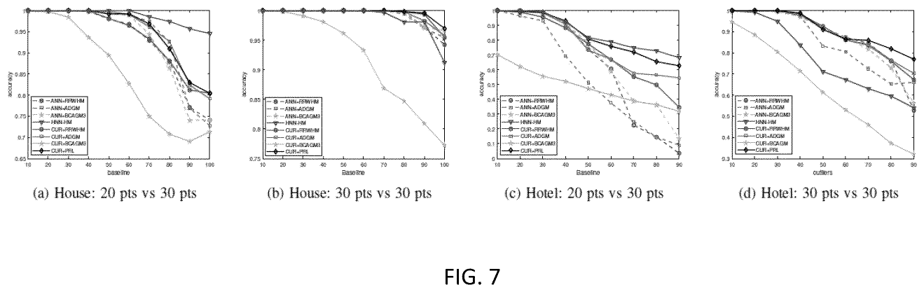

The sequence-matching results are shown in FIG. 7. The dashed curves represent the matching results on the compatibility tensors using the ANN-based method. The solid curves with the same color denote the matching accuracy on tensors generated by the proposed CUR-based method with the same hypergraph matching algorithms.

All the learning-free-based matching algorithms with the CUR based method have matching accuracy surpassing the ANN based ones in all cases except the BCAGM3 algorithm. The BCAGM3 algorithm with the CUR-based method frequently had descent errors during the experiment. Its matching accuracy heavily decreases when the compatibility tensor is too sparse. The PRL-based matching algorithm with the CUR-based method has comparable matching accuracy with the state-of-the-art learning-free-based matching algorithms when the outlier is ten and has higher matching accuracy for the 30-vs-30 points problem on the House dataset. For the

Hotel dataset, the method according to an embodiment of the present invention is configured to first considers the distance and rotation invariance during the second-order graph matching process and, therefore, has a much higher matching accuracy than the ANN-based methods. Compared with deep-learning-based HNN-HM, the method of the present invention falls behind on 20-vs-30 problems because the deep-learning-based HNN-HM is specialized trained on the House Dataset. However, the method of the present invention still achieves the best matching result in the 30-vs-30 problems. The method of the present invention solves the matching problem with a unified model, and HNN-HM, on the other hand, must first train separating models in different datasets to achieve a better matching result.

The present invention is used to process the Car and Motorbikes dataset which consists of 30 real-life car image pairs and 20 motorbike image pairs with different scales, feature points, and shapes. In this experiment, the inlier points in both images are kept and outlier points in the second image are randomly chosen, with the number varying from 0 to 30 with step 5. t=n₁n₂ hyperedges are calculated in the first image. For traditional methods, r₁ is set as 0.3n₁n₂. For methods according to embodiments of the present invention, r=50 nearest neighbors in each tensor block will be chosen, and k is set as 10. c=300 for initial guess during CUR-based second-order graph matching.

Every image pair in the dataset are matched. The system reported the average accuracy with ANN and CUR-based tensor generation methods. The system also reported the average number of nonzero elements in the tensors generated by two methods.

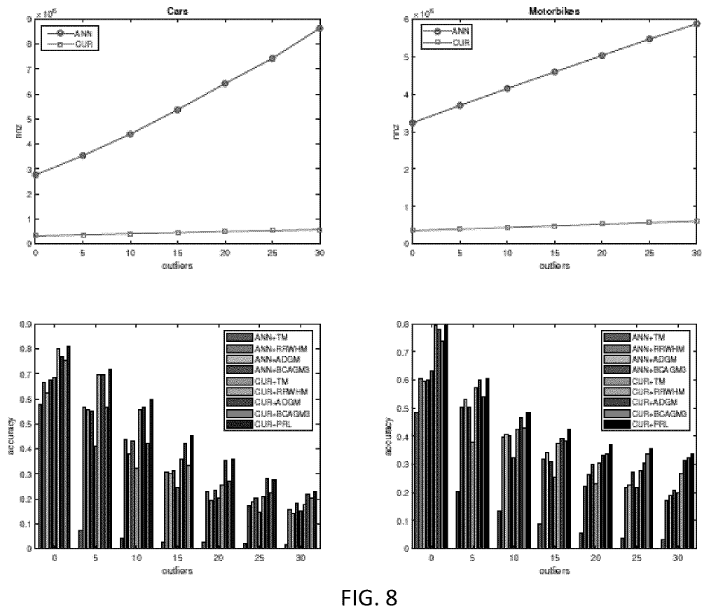

The comparison result is shown in FIG. 8. The first column of the figures are the results from the Cars dataset, and the second column denotes the results from the Motorbikes dataset.

One can observe that with more than ten times sparser than the ANN-based method, the graph matching algorithm can achieve higher accuracy with the CUR-based proposed method for the same matching algorithm. The PRL-based matching algorithm of the present invention can achieve higher accuracy than state-of-the-art hypergraph matching algorithms in most cases.

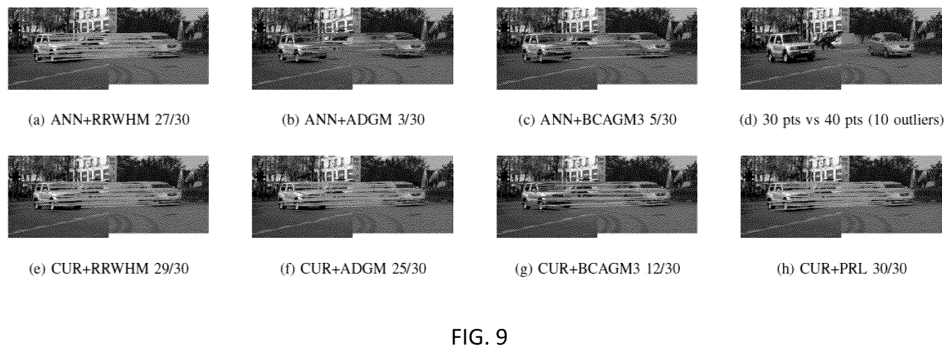

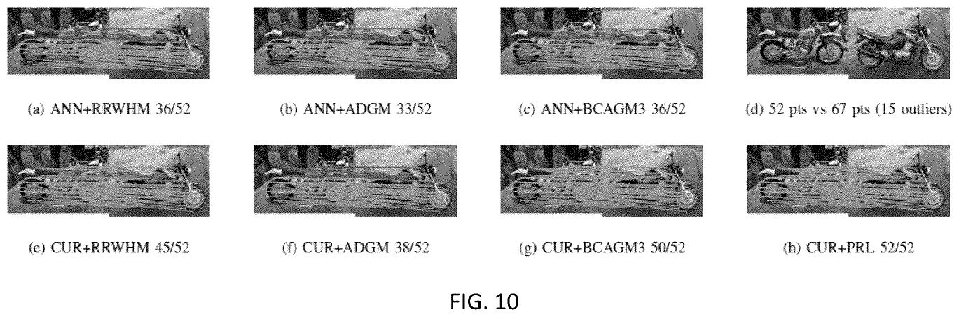

FIGS. 9 and 10 show several matching examples. FIG. 9 shows the Car datasets matching example using various third-order hypergraph matching algorithms with ANN and CUR-based tensor generation methods. 30 inlier points are in both images, with 10 outliers in the second. The green lines denote the correct matching, and the red ones denote the mismatches. FIG. 10 shows Motor datasets matching example using various third-order hypergraph matching algorithms with ANN and CUR-based tensor generation methods. 52 inlier points are in both images, with 15 outliers in the second. The green lines denote the correct matching, and the red ones denote the mismatches.

With the same hypergraph matching algorithm, the CUR-based method leads to fewer mismatches. The proposed PRL-based matching algorithm with the CUR based tensor generation method has the highest matching accuracy.

To analyze the influence of the CUR-based second-order matching result, the processing unit is configured to generate the whole compatibility matrix for a 100-vs100 point synthetic dataset with σ=0.02 first. The processing unit is configured to calculate the CUR decomposition with less than 100 columns and the relaxed assignment matrix with a second-order PRL-based matching algorithm. The hit rate with the increasing k is calculated based on the assignment matrix, which is defined as

$$\frac{{\sum }_{i} {δ}_{i}}{{n}_{1}} ,$$

where

$${δ}_{i} = \{ \begin{matrix}1 & The true match j ∈ {i}_{} \\ 0 & Otherwise\end{matrix} \qquad ( 22 )$$

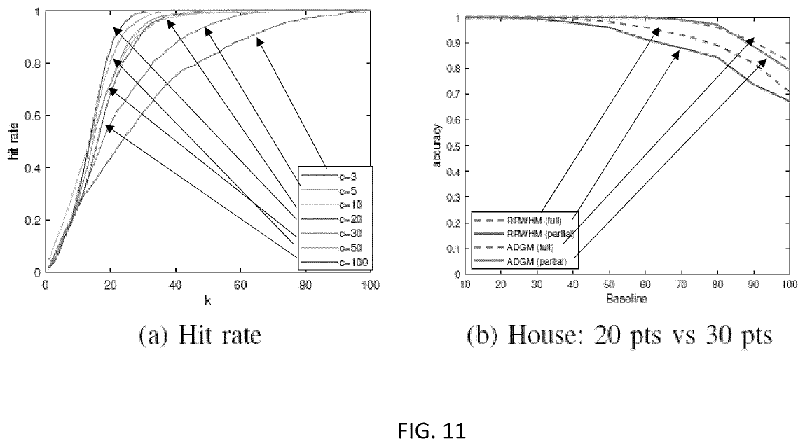

The result is shown in FIG. 11 (a). Each curve represents how many columns are randomly selected during CUR decomposition. The hit rate is higher with more columns selected but does not increase too much with more than ten columns.

The influence of the second-order graph matching result are further analyzed by implementing it on the House dataset with 20-vs-30 point problems. The processing unit is configured to set t=3n₁n₂ and r=n₁n₂ for the ANN-based tensor generation method. Then the processing unit is configured to directly select the corresponding fibers with the result of the CUR-based second-order matching algorithm on the tensor blocks to simulate the compatibility tensor generated by the CUR-based method. c is set as 10. The matching result with RRWHM and ADGM is shown in FIG. 11 (b). The matching result using the non-zero elements of the corresponding fibers leverages the one using all the non-zero elements generated by the ANNbased method. Therefore, it can be proved that the fibers selected by the CUR-based second-order graph-matching results are preferable.

In one embodiment of the present invention, the processing unit is configured to analyze how the selection of k and r affects the final matching accuracy. In this experiment, the processing unit is configured to use the proposed PRL-based hypergraph matching algorithm to analyze the effect of the compatibility tensor. The processing unit is configured to use a 100-vs-120 points synthetic dataset with various noise deviation o for the dataset.

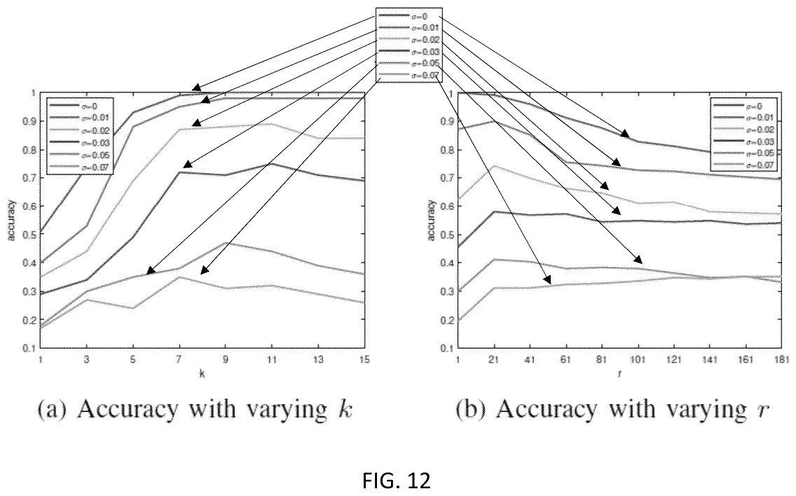

To analyze the influence of k, the processing unit is configured to first set r=50 and vary k from 1 to 15 with a step of 2. The result is shown in FIG. 12 (a). FIG. 12 (a) shows the matching accuracy with increasing points selected from the second-order graph matching algorithm. FIG. 12 (b) shows the matching accuracy with increasing nearest neighbor in each tensor block.

For the low noise level, the matching accuracy increases fast at first and then converges to 1, which has a similar curve as in FIG. 11 (a). It can be observed that a higher k contributes to a higher matching accuracy. However, the computation will be polynomially increased as k increases. For the matching result with a high noise level, like when σ≥0.02, the matching accuracy increases to its highest and gradually decreases. For σ=0.03, the highest point is at k=11. For σ=0.05, it decreases since k=9. The maximum point drifts to the smaller k as σ increases. Therefore, the larger k may decrease the matching accuracy if the target points are heavily damaged.

The effects of r are analyzed by setting k=5 and varying r from 1 to 181 with a step of 20. The final result is shown in FIG. 12 (b). Unlike the results in FIG. 12 (a), the matching accuracy decreases from its peak for the low noise level. For the denoised points, the second-order graph-matching algorithm itself can have a relatively high accuracy. If the processing unit is configured to select too many nearest neighbors on the tensor fibers, these elements could interfere with the third-order matching and decrease the final results. The true matched hyperedge may not have the highest similarity for the high noise level. Therefore, the matching accuracy peaks when r is around 20 and gradually decreases. It can be noticed that for σ=0.07, the matching accuracy has a continuing increase. The maximum point slowly drifts to a higher r, which is opposite to the effects of k.

In conclusion, a higher k helps lead to a higher matching accuracy. However, it may also decrease the matching performance if the points are heavily deformed. Likewise, a denser tensor block fiber may decrease the performance of graph-matching algorithms. The optimal parameters k and r for the best matching results are varied in different matching problems, which are configurable by the processing unit.

The effect of the parameters on the PRL-based matching algorithm is finally analyzed.

The system of the present invention is configured to apply the ANN-based and CUR-based tensor generation method on a 100-vs-120 points synthetic dataset with σ ε [0,0.1]. For the ANN-based method, the processing unit is configured to set t=1200 and r₁=200.

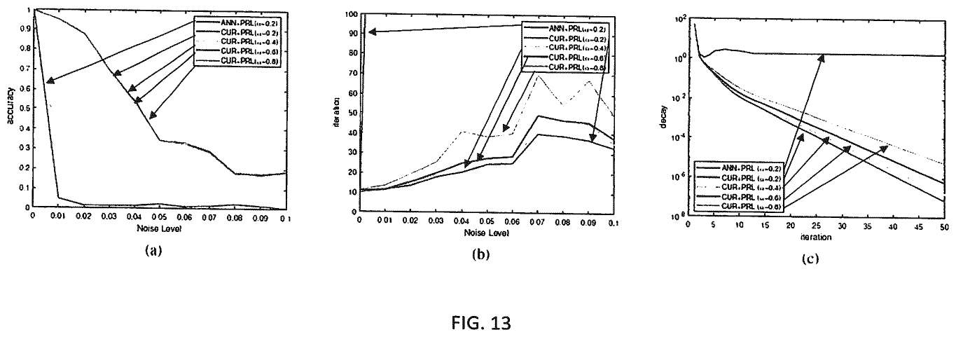

The PRL-based matching algorithm is evaluated on both compatibility tensors with αε [0,1]. For the CUR-based method, the processing unit is configured to set k=5 and r=25. To analyze the convergence of the algorithm, the processing unit is configured to set the stopping criteria of the PRL-based algorithm as ∥x^{k+1}−x^{k}∥₂≤10⁻⁸ and max iteration as 1000. FIG. 13 (a) shows the average matching accuracy using ANN-PRL and CUR-PRL with different α. FIG. 13 (b) shows the corresponding average convergence iterations. ANN-PRL doesn't converge for σ≥0.01. FIG. 13 (c) shows ∥x^{k+1}−x^{k}∥₂ during iteration k with different a settings using CUR-PRL and ANN-PRL. σ is set as 0.1. With the compatibility tensor generated by the CUR-based method, the PRL algorithm shows an equal matching result regardless of α. However, the matching result with the ANN-based method shows almost zero matching accuracy. A smaller α can result in fewer convergence iterations for the CUR-based method, and the PRL-based algorithm hardly converges for the ANN-based method. Therefore, the PRL-based method is quite suitable for the proposed CUR-based method.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilized. This will include tablet computers, wearable devices, smart phones, Internet of Things (IoT) devices, edge computing devices, stand alone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A computer system for second-order graph matching, said system comprising:
a memory storing a representation of at least two set of nodes ( [symbol] ₁, [symbol] ₂) and a compatibility matrix (H) representing similarities between edges of the nodes;
a processing unit configured to receive the compatibility matrix and execute machine instructions comprising the steps of:
retrieving a subset of columns and rows from the compatibility matrix (H) in the memory to compose a first matrix (C);
conducting CUR decomposition of the tensor to generate an approximation matrix formed by the first matrix and a second matrix (U_{*}); and
applying a soft-constraint second-order graph-matching algorithm on the approximation matrix to generate an assignment matrix (X);
identifying a predetermined entries (k) with highest probabilities in the assignment matrix as match sets of the nodes ( [symbol] ᵢ).

2. The system of claim 1, wherein each of the at least two set of nodes has a cardinal greater than the columns and rows of the first matrix.

3. The system of claim 1, wherein the compatibility matrix is decomposed with the first matrix (C) and a second matrix (U_{*}), wherein each of the first matrix and second matrix has a small size than that of the compatibility matrix.

4. The system of claim 3, wherein the second matrix is generated by
$${U}_{*} = arg {min}_{U} {‖ {R}_{Ω} ( H ) - {R}_{Ω} ( C U {C}^{T} ) ‖}_{F} .$$

5. The system of claim 4, wherein the first matrix (C) comprises randomly selected columns and rows retrieve from the compatibility matrix (H).

6. The system of claim 5, wherein the machine instructions further comprise the step of generating a compatibility tensor with respect to the match sets of the nodes ( [symbol] ᵢ).

7. The system of claim 6, wherein the compatibility tensor is a sparse tensor.

8. The system of claim 7, wherein the compatibility tensor is generated by a Fiber-CUR-based tensor generation.

9. The system of claim 8, wherein the Fiber-CUR-based tensor generation comprises the steps of:
selecting hyperedges from one of the match sets of the nodes ( [symbol] ₁);
comparing the selected hyperedges with three subgraphs {i₂,j₂,:}, {i₂,:,k₂}, {:,j₂,k₂} ε [symbol] ₂ where i₂ [symbol] ᵢ_{₁},j₂ ε [symbol] ⱼ_{₁}, and k₂ ε [symbol] ₖ_{₁};
selecting r nearest neighbors for each hyperedge in the source graph to generate the compatibility tensor.

10. The system of claim 9, wherein the machine instructions further comprise the step of generating a relaxed assignment matrix (X) with respect to the compatibility tensor.

11. A system of claim 10, wherein the relaxed assignment matrix (X) is generated by a probabilistic relaxation labeling algorithm.

12. The system of claim 11, wherein probabilistic relaxation labeling algorithm comprises the step of generating the probability of node I from one of the match sets of the nodes and node j from another match sets of the nodes.

13. The system of claim 12, wherein the probability of node i is associated with node j is represented by
$${p}_{i}^{( k + 1 )} ( j ) = \frac{{[ {\sum }_{l} {\sum }_{m} {R}_{i l} ( j , m ) {p}_{l}^{( k )} ( m ) ]}^{2}}{{{\sum }_{i} [ {\sum }_{l} {\sum }_{m} {R}_{i l} ( j , m ) {p}_{l}^{( k )} ( m ) ]}^{2}} .$$

14. The system of claim 13, wherein the probability is replaced with the vector x, wherein which x is the columnwise flatten of a soft-constraint assignment matrix.

15. The system of claim 14, wherein the vector x is adapted to be normalized as
$${\hat{x}}^{( k + 1 )} = {( α \hat{m} ⊙ {x}^{( k )} + ( 1 - α ) {⊗}_{1} {x}^{( k )} {⊗}_{2} {x}^{( k )} )}^{2} .$$

16. The system of claim 15, wherein the relaxation labeling algorithm halts when relaxed assignment matrix X converges.

17. The system of claim 16, wherein the at least two set of nodes ( [symbol] ₁, [symbol] ₂) are corresponding points from templates with regular shapes.

18. The system of claim 17, wherein the templates with regular shapes are constructed from the features of the objects to be matched.

19. The system of claim 16, wherein the at least two set of nodes ( [symbol] ₁, [symbol] ₂) are corresponding points from two images of the same object taken under different conditions, including two objects to be matched from two images or two frames of a video.

20. The system of claim 19, wherein at least two set of nodes ( [symbol] ₁, [symbol] ₂) are corresponding feature points, and shapes from different 2D and 3D objects.
